(19) United States
(12) Patent Application Publication
(10) Pub. No.: US 2024/0144051 A1
(43) Pub. Date: May 2, 2024

(54) HARDWARE-AWARE GENERATION OF MACHINE LEARNING MODELS

(71) Applicant: Microsoft Technology Licensing, LLC, Redmond, WA (US)

(72) Inventors: Gilad KIRSHENBOIM, Petach Tiqva (IL); Ofer DEKEL, Redmond, WA (US); Shital SHAH, Sammamish, WA (US); Debadeepta DEY, Kenmore, WA (US); Segev RAVGAD, Ramat Hasharon (IL)

(73) Assignee: Microsoft Technology Licensing, LLC, Redmond, WA (US)

(21) Appl. No.: 17/978,587

(22) Filed: Nov. 1, 2022

(51) Int. Cl. G06N 5/04; G06N 20/20

(52) U.S. Cl. CPC G06N 5/04; G06N 20/20

(57) ABSTRACT

This document relates to automated generation of machine learning models, such as neural networks. One example method involves obtaining a first machine learning model having one or more first inference operations. The example method also involves identifying a plurality of second inference operations that are supported by an inference hardware architecture. The example method also involves generating second machine learning models by modifying the first machine learning model to include individual second inference operations that are supported by the inference hardware architecture. The example method also involves selecting a final machine learning model from the second machine learning models based on one or more metrics.

### BACKGROUND

Traditionally, machine learning models were manually generated by experts who would define the model and then use automated techniques for model training. As machine learning models have grown more complex, various attempts have been made to automate the process of generating machine learning models. Machine learning models generated using automated techniques can be very accurate, but such models may not fully leverage certain efficiencies provided by modern computing hardware.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for automated generation of machine learning models. One example includes a method or technique that can be performed on a computing device. The method or technique can include obtaining a first machine learning model having one or more first inference operations. The method or technique can also include identifying a plurality of second inference operations that are supported by an inference hardware architecture. The method or technique can also include generating second machine learning models by modifying the first machine learning model to include individual second inference operations that are supported by the inference hardware architecture. The method or technique can also include selecting a final machine learning model from the second machine learning models based on one or more metrics.

Another example includes a system that include a hardware processing unit and a storage resource. The storage resource can store computer-readable instructions which, when executed by the hardware processing unit, cause the hardware processing unit to perform a search of a machine learning model search space having a plurality of inference operations that are supported by an inference hardware architecture. The search can involve emulation of the inference architecture hardware. The computer-readable instructions can also cause the hardware processing unit to output a final machine learning model selected from the machine learning model search space.

Another example includes a system that entails a hardware processing unit and a storage resource. The hardware processing unit can be configured to execute a plurality of supported inference operations. The computer-readable instructions, when executed by the hardware processing unit, cause the hardware processing unit to determine a device context for the computing device and select a particular machine learning model from a plurality of machine learning models available to the computing device. The plurality of machine learning models can have different supported inference operations. The computer-readable instructions can also cause the hardware processing unit to execute the particular machine learning model to perform a particular task.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example machine learning model evolutionary search procedure, consistent with some implementations of the present concepts.

FIGS. 2A, 2B, 2C, and 2D illustrate examples of modifications that can be performed to machine learning models during a search procedure, consistent with some implementations of the present concepts.

FIG. 3 illustrates an example model generation workflow for generating a machine learning model, consistent with some implementations of the present concepts.

FIGS. 4-6 illustrate scatterplots associated with consecutive iterations of a machine learning model search procedure, consistent with some implementations of the present concepts.

FIG. 7 illustrates an example system, consistent with some implementations of the present concepts.

FIG. 8 illustrates an example graphical user interface, consistent with some implementations of the present concepts.

FIG. 9 is a flowchart of an example method for hardware-aware generation of machine learning models, consistent with some implementations of the present concepts.

FIG. 10 is a flowchart of an example method for dynamic runtime selection of a machine learning model, consistent with some implementations of the present concepts.

### DETAILED DESCRIPTION

### Overview

As previously noted, one way to generate a machine learning model is for a human to manually define the structure of the model. Then, the model can be trained on some training data set by a computer to obtain a trained model, and then the trained model can be validated using a validation data set. Subsequently, modifications to the structure of the model can be generated manually, e.g., by adding or removing operations or connections between operations. Then, the modified machine learning models can be trained again to obtain additional trained models, and the additional trained models can be compared to one another to select a final model and corresponding structure that works well for a given task. However, this approach requires the involvement of a human with domain expertise to create the initial model structure and the modifications, and also to select the final model structure.

Another approach is to automate the process of generating a machine learning model by using a computer. For instance, a computer can generate different candidate machine learning models and then select a final model from among the candidates. While this approach can produce very accurate models for a wide range of tasks, the resulting models may not be particularly efficient. For instance, when models are automatically generated by prioritizing accuracy over efficiency, the resulting models may tend to run relatively slowly (e.g., have high latency), exhibit high memory utilization or power consumption, etc.

One way to produce an efficient machine learning model is to execute the model on inference hardware, such as a neural processing unit, that provides dedicated hardware support for inference operations. For instance, neural processing units can provide dedicated instructions and circuitry to perform convolution operations, vector operations, matrix operations, pooling operations, activation function operations, etc. However, conventional automated techniques for generating machine learning models tend to generate models with inference operations that are not directly supported by available inference hardware architectures. For instance, a given inference hardware architecture might provide a discrete set of convolution or matrix operations with specified input or output sizes, and a machine learning model generated using conventional automated techniques might include convolution or matrix operations with different data sizes that are not directly supported by that inference hardware architecture.

The disclosed implementations provide techniques for automatically generating machine learning models in a manner that considers the availability of specific inference operations provided by a particular inference hardware architecture. As a consequence, the disclosed implementations can automatically generate models that are far more efficient than those generated using traditional techniques that do not consider the availability of hardware-supported inference operations during model generation. Moreover, models generated using the techniques described herein can still provide comparable accuracy to models generated using traditional techniques.

### Machine Learning Background

There are various types of machine learning frameworks that can be trained to perform a given task, such as estimating the quality of a signal or enhancing a signal. Support vector machines, decision trees, and neural networks are just a few examples of machine learning frameworks that have been used in a wide variety of applications, such as image processing and natural language processing. Some machine learning frameworks, such as neural networks, use layers of operations or “nodes” that are connected together by one or more edges.

In a neural network, nodes are connected to one another via one or more edges. A neural network can include an input layer, an output layer, and one or more intermediate layers. Individual nodes in each layer can perform specific operations on their inputs, such as convolution operations, vector operations, matrix operations, pooling operations, or activation function operations. Each operation can provide an output to a subsequent layer, or, in some cases, a previous layer. The inputs to a given node can be multiplied by corresponding weight values for an edge between the input and the node. In addition, nodes can have individual bias values that are also used to produce outputs. Various training procedures can be applied to learn the edge weights and/or bias values.

Neural networks and other machine learning models can be viewed as operating in two phases—training and inference. In the training phase, the model is used to make predictions given training data and the model parameters are updated based on whether those predictions are correct. In the inference phase, the trained model is employed to process input data to perform a particular task, often without further modification to the model parameters. Training can involve algorithms such as batch gradient descent that perform calculations of an error gradient to update the model parameters. In contrast, inference generally does not involve such calculations. Because inference processing does not necessarily involve training calculations, it is possible to build special-purpose inference hardware that is particularly efficient at performing inference operations and does not necessarily need to fully support model training.

For instance, an inference hardware architecture might be implemented as a systolic array. In such an array, input data can be divided and distributed to a group of parallel nodes that each perform the same operation on a subset of the input data, and then pass the results of their processing to the next group of nodes in the array. For instance, individual hardware nodes can perform multiply and accumulate operations on specified data sizes very quickly, e.g., using dedicated circuitry to perform large convolution or matrix multiplication operations in relatively few processing cycles and using relatively few memory transfer operations. For instance, a large matrix or vector can be loaded into or output to memory in a single operation.

In contrast, implementing a large convolution or matrix multiplication on a conventional CPU tends to involve executing a long stream of sequential operations. Individual instructions can retrieve portions of matrices or vectors from memory and process them individually, and then subsequent operations can combine intermediate results into a final output. As a consequence, complex convolution or matrix operations tend to be far less efficient on general-purpose CPU's than when implemented on dedicated inference hardware. A CPU implementation of a large convolution or matrix operation can have far higher latency, power consumption, and/or memory utilization than the same operation implemented using hardware-supported inference operations. However, models that do not include specific inference operations (e.g., data sizes) that are supported in inference hardware cannot fully take advantage of these efficiencies.

### Neural Architecture Search Procedure

There are various approaches for searching a machine learning model search space to identify a final model. For instance, as discussed more below, the disclosed techniques can be employed to perform a neural architecture search using evolutionary approaches, reinforcement learning approaches, Bayesian optimization approaches, hill-climbing approaches, one-shot approaches, etc. The following discussion uses an evolutionary approach as a specific example of how the disclosed concepts can be employed for automated generation of machine learning models. However, as discussed more further below, the disclosed concepts can be readily incorporated into other approaches for generating machine learning models.

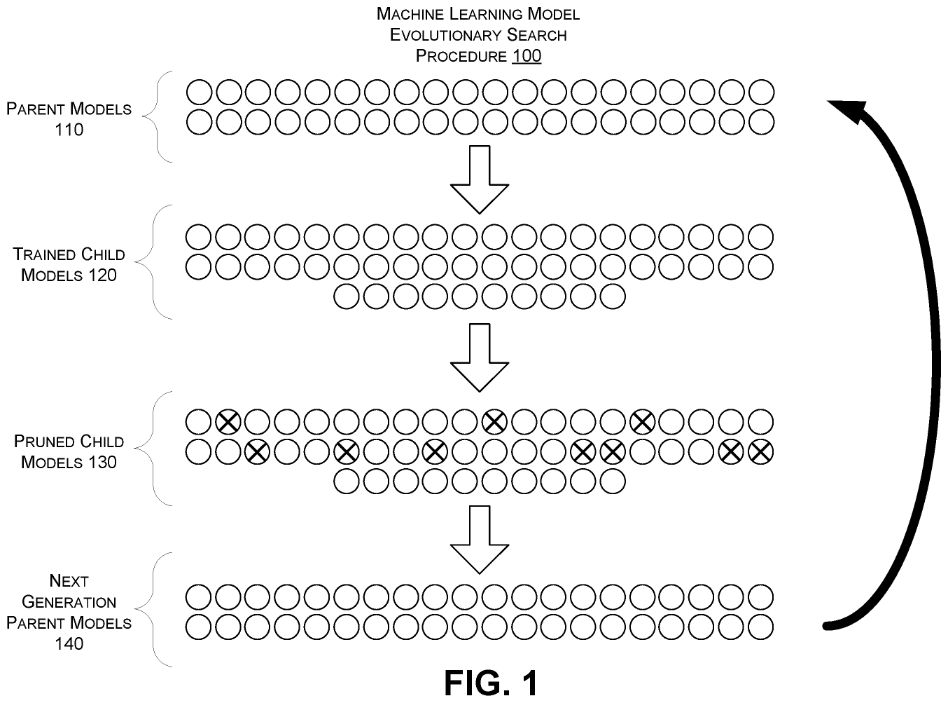

FIG. 1 illustrates an example machine learning model evolutionary search procedure 100. First, parent models 110 are modified and trained to include trained child models 120. As described more below, in some cases the parent models are modified to include inference operations that are supported by a target inference hardware architecture. In addition, in some cases the parent models are modified by removing other inference operations that are not supported by the target inference hardware architecture. Parent models can also be modified by adding or removing connections between individual inference operations.

Next, the trained child models 120 are pruned to obtain pruned child models 130. For instance, the trained child models can be pruned to remove individual child models that perform relatively less well than other child models with respect to one or more metrics. As discussed more below, the metrics can relate to loss or accuracy, latency, power consumption, memory utilization, etc.

After pruning, the remaining trained child models are designated as next generation parent models 140. Further iterations of the model search can be performed by training and pruning further child models until a stopping condition is reached, at which point a final model can be selected from the available child models. In some cases, the model search can proceed until all unsupported inference operations have been removed and all of the remaining models include only inference operations that are supported by the target hardware architecture. In other cases, the model search can allow for unsupported inference operations to remain, in which case the unsupported inference operations can be implemented on conventional CPUs or by using mathematically-equivalent operations that are supported by the target inference architecture.

### Example Model Modifications

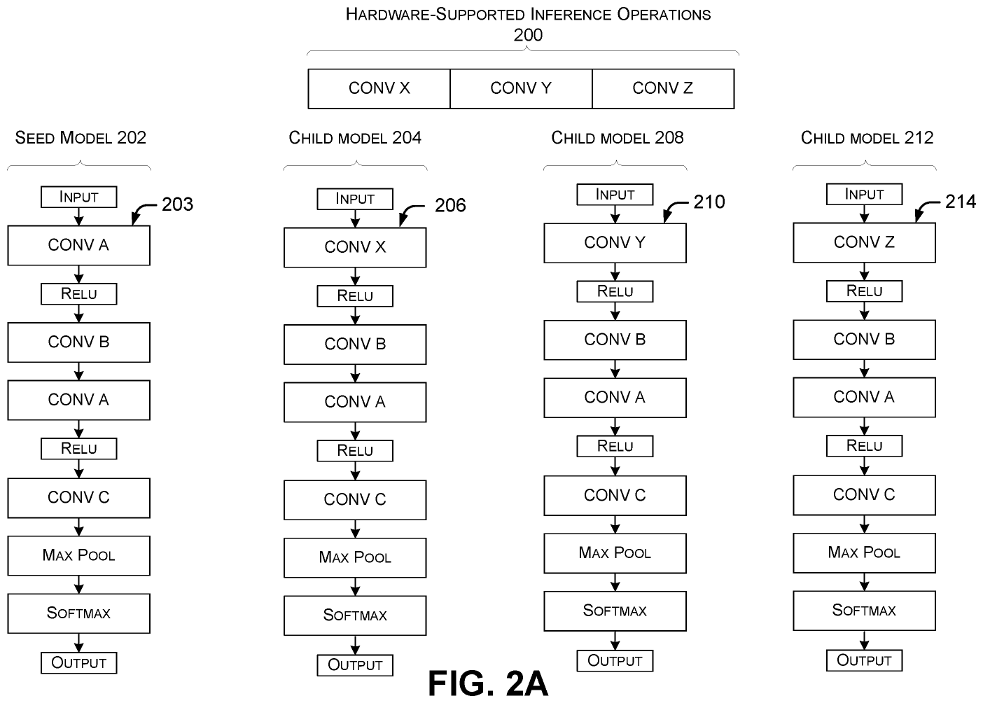

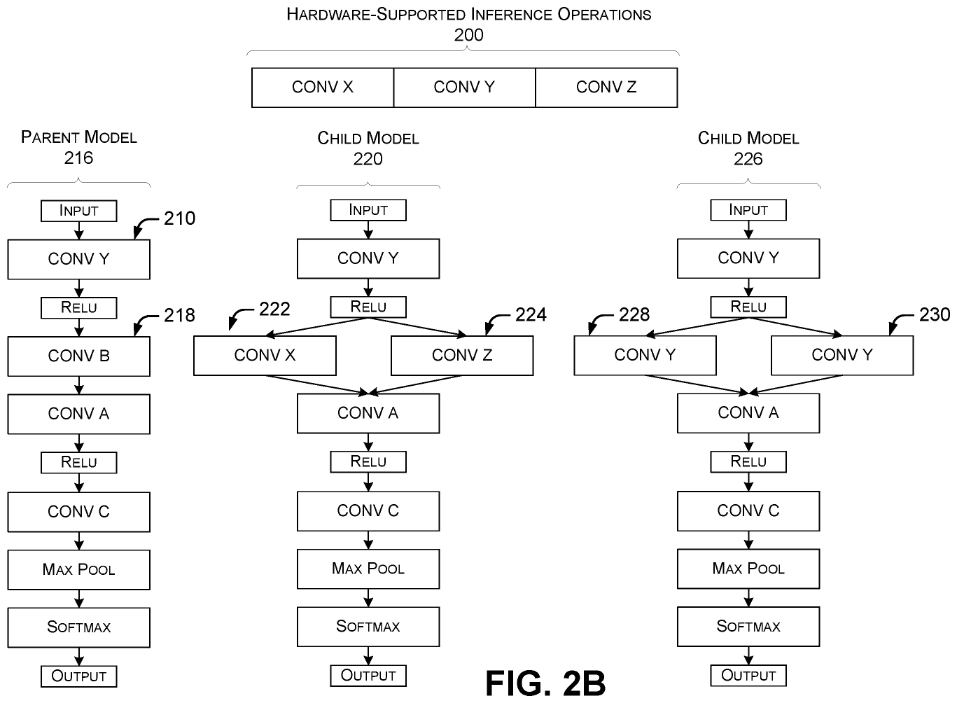

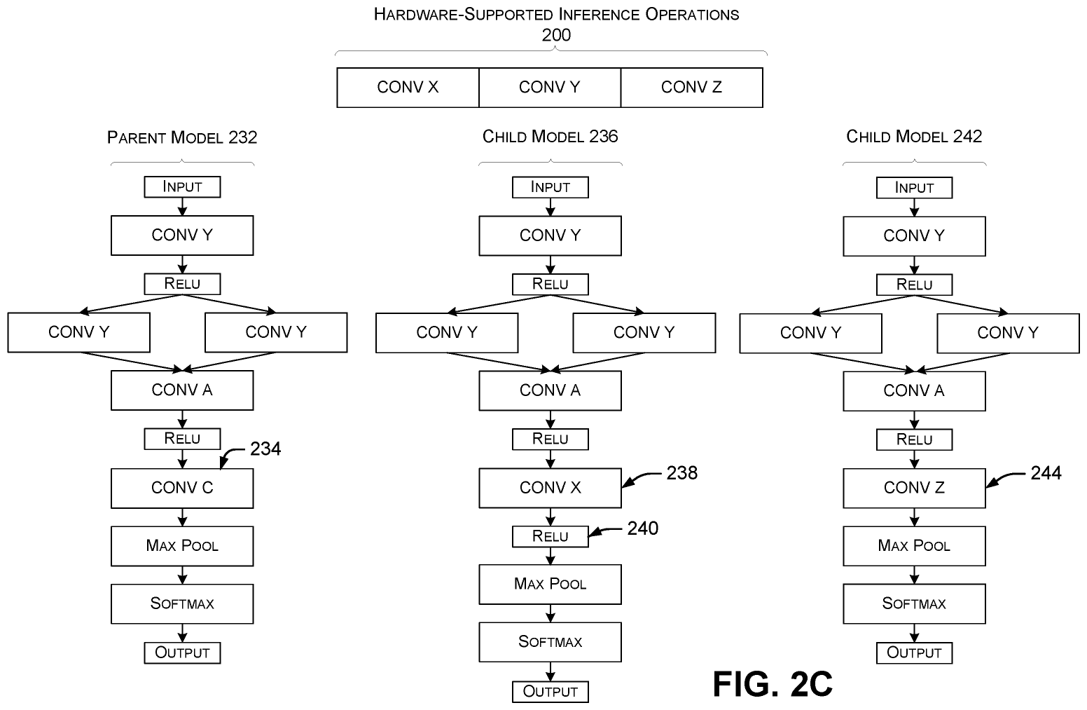

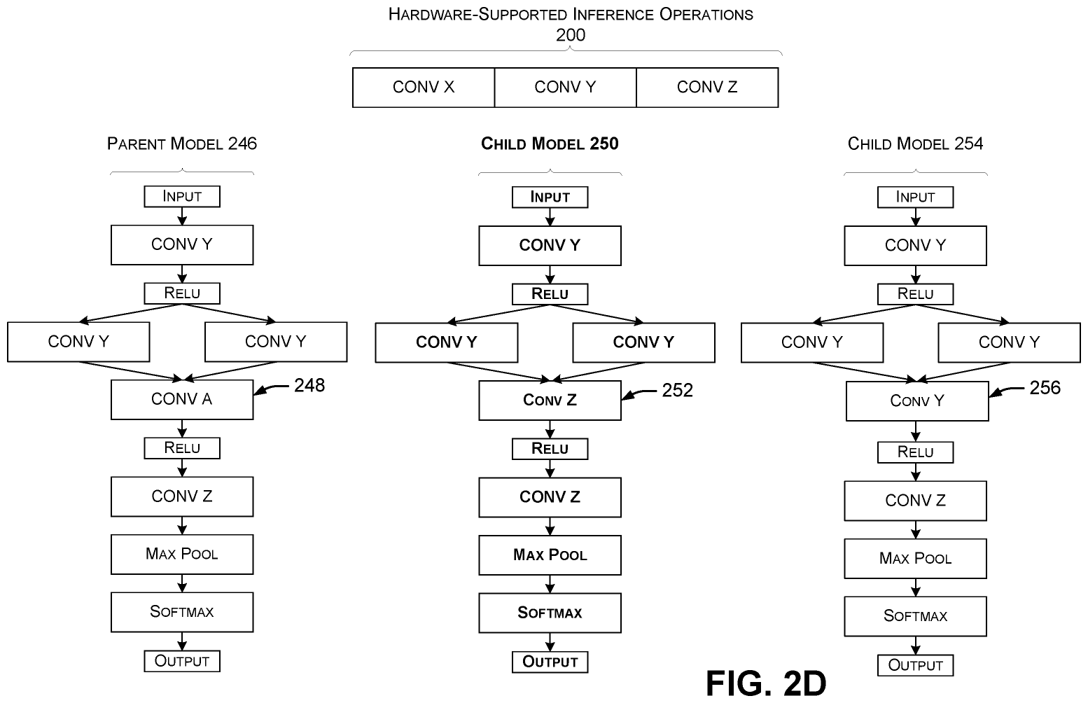

FIGS. 2A, 2B, 2C, and 2D illustrate example modifications that can be performed to transform parent models into child models. FIG. 2A shows hardware-supported inference operations 200, which include three specific inference operations—CONV X, CONV Y, and CONV Z. For instance, each inference operation can be a convolution operation with a specific input/output tensor size and/or kernel size that is supported by a target inference hardware architecture. In other words, a given processing unit that implements the target inference hardware architecture has dedicated circuitry for performing convolution operations with those tensor and/or kernel sizes, e.g., potentially using a single machine instruction (e.g., opcode). The dedicated circuitry for implementing a given convolution operation can have parallel hardware nodes, each of which can perform a part of the convolution operation on a portion of input data to produce a portion of output data. The output data can be combined and further processed using further circuitry provided by the processing unit that implements the target hardware architecture.

Seed model 202 can be a model that was originally developed without considering the target inference architecture. For instance, seed model 202 can be a model that was developed manually or using automated techniques and is known to perform well for a particular task, such as a particular image processing operation (e.g., background segmentation, object recognition, etc.). Seed model 202 includes three types of convolution operations, A, B, and C, that are not among those supported by the target hardware architecture. In other words, convolution operations A, B, and C may have different tensor and/or kernel sizes than those available from the hardware-supported operations. As described more below, multiple iterations of a machine learning model search procedure can be performed starting with seed model 202 as a parent model. In each iteration, one or more operations or connections between operations can be added or removed until a final model is generated, where the final model can include operations that perform similar functionality to the seed model but are supported by the target inference hardware architecture.

In a first model search iteration, convolution A operation 203 of seed model 202 can be replaced to generate child models 204, 208, and 212. Child model 204 be generated by replacing the convolution A operation with convolution X operation 206, child model 208 can be generated by replacing the convolution A operation with convolution Y operation 210, and child model 212 can be generated by replacing the convolution A operation with convolution Z operation 214. As described above, the respective child models can be trained and one or more of the child models selected as a parent model for the next generation of models.

Assume, for the purposes of example, that child model 208 is selected as a parent model for the next generation, redesignated as parent model 216 in FIG. 2B. This parent model can be modified by replacing convolution B operation 218 to generate child models 220 and 226. Child model 220 can be generated by replacing the convolution B operation with convolution X operation 222 and convolution Z operation 224. Child model 226 can be generated by replacing the convolution B operation with convolution Y operation 228 and convolution Y operation 230. As described above, the respective child models can be trained and one or more of the child models selected as a next-generation parent model.

Assume, for the purposes of example, that child model 226 is selected as the parent model for the next generation, redesignated as parent model 232 in FIG. 2C. This parent model can be modified by replacing convolution C operation 234 to generate child models 236 and 242. Child model 236 can be generated by replacing the convolution C operation with convolution X operation 238 and ReLu operation 240. Child model 242 can be generated by replacing the convolution C operation with convolution Z operation 244.

Now, assume that child model 242 is selected as the parent model for the next generation, redesignated in FIG. 2D as parent model 246. This parent model can be modified by replacing convolution A operation 248 to generate child models 250 and 254. Child model 250 can be generated by replacing the convolution A operation with convolution Z operation 252. Child model 254 can be generated by replacing the convolution A operation with convolution Y operation 256.

At this point, a stopping condition may be reached and a final model selected from the models generated so far. For example, child model 250 may be selected as final model, shown in FIG. 2D by bold text. The final model can be output for execution on inference hardware to perform a particular task that the model has been trained to do. Thus, referring back to FIG. 2A, seed model 202 has been transformed into a final model that can perform the same task as the seed model, but using inference operations that are supported by the target inference hardware architecture. Thus, the final model can provide similar functionality as the seed model while leveraging the efficiencies provided by the target inference hardware architecture.

### Example Model Generation Workflow

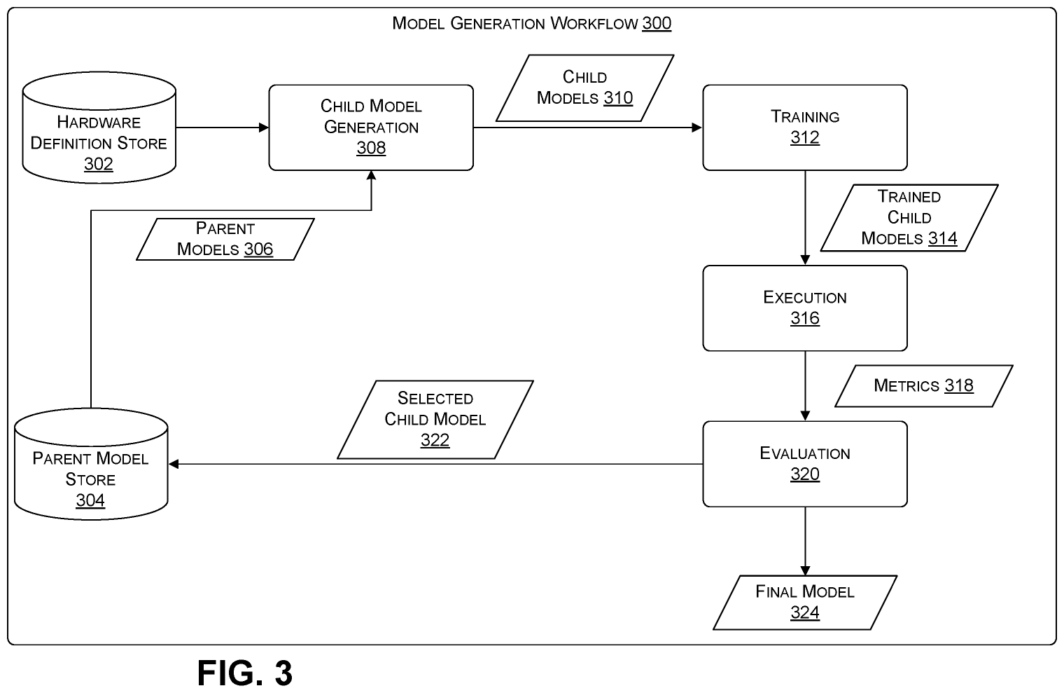

FIG. 3 illustrates an example model generation workflow 300 that can be employed to search a machine learning model space having operations supported by an inference hardware architecture. Hardware definition store 302 stores one or more hardware definitions identifying certain inference operations that are supported in hardware, such as convolution operations X, Y, and Z illustrated above in FIGS. 2A-D. Parent model store 304 stores parent models that can be replaced with new parent models over time, as described more below. In some cases, the parent model store is initialized using one or more seed models, e.g., that are selected based on their performance (e.g., accuracy) at a particular task. Subsequent generations of parent models can be used to populate the parent model store over time.

For each generation, one or more parent models 306 can be retrieved from the parent model store and input to child model generation 308. The child model generation can use the inference operations available in the hardware definition store 302 to produce child models 310. The child models can be trained at 312 to produce trained child models 314, e.g., using supervised learning, unsupervised learning, transfer learning, etc. The trained child models can be executed at 316 to obtain metrics 318. For instance, the metrics can characterize accuracy or losses of the trained child models, latency (e.g., execution times) of the trained child models, power consumption or memory utilization of the trained child models, etc.

The metrics can be used to evaluate the trained child models to identify selected child models 322. For instance, in some cases, the child models are selected based on a trade-off between two or more metrics, e.g., by selecting child models that have relatively high accuracy and relatively low power consumption. A similar approach can also be used to select a final model 324 upon reaching a stopping condition.

Child model generation 308 can involve replacing or adding operations and/or connections between operations, as shown above with respect to FIGS. 2A-2D. For instance, child model generation can involve random or deterministic approaches for selecting operations to add to parent models, operations to remove from child models, and/or connections to add or remove between individual operations. In some implementations, child model generation is constrained fully by the operations supported by a target inference hardware architecture, e.g., only supported operations are added to a given child model. In other implementations, the model space can be explored by considering both supported and non-supported operations, in some cases by favoring selection of supported operations over non-supported operations using a weighting scheme.

### Refinements

In some case, the techniques described above can be performed by simulating the target hardware using general-purpose hardware, without executing the models on hardware that implements the target inference hardware architecture and without emulating the target inference hardware architecture. Simulating execution of a model can involve approximating the functionality of a given target hardware architecture without directly implementing the underlying inference operations that are supported by the target hardware architecture. Using simulation, it is still possible to predict the accuracy of a given model, because general-purpose hardware can be used to simulate and execute operations that are mathematically or logically equivalent to those supported by the target inference hardware architecture.

For instance, on a general-purpose CPU, it may take hundreds or thousands of operations and processing cycles to implement a convolution or matrix operation that can be executed using a single operation by an NPU, in only a few processing cycles. However, because the operations are mathematically or logically equivalent (or at least approximately so), the accuracy or loss of a given model can still be estimated on the CPU. Thus, a general CPU can be used to transform an initial seed model with operations that are not supported by a target inference hardware architecture into a final model that is fully supported by the target inference hardware architecture. Even assuming simulation on the CPU cannot, without emulation, estimate the performance of the final model with respect to latency, power consumption, or resource utilization, it is nevertheless likely that the final model will still exhibit significant improvements relative to the seed model given that the final model can leverage the efficiencies provided by the target inference hardware architecture.

In further implementations, hardware emulation of individual operations supported by the target inference hardware architecture can further guide the search. In hardware emulation, a CPU can implement operations that directly correspond to the inference operations of a given model. In other words, the CPU can replicate the target hardware architecture by mapping each inference operation in a given model to a corresponding set of CPU instructions that are designated for emulating that inference operation. By using emulation, performance information about each model can be inferred. For instance, the overall latency, power consumption, and/or resource utilization of a given model can be estimated based on the emulation. This allows for a multi-objective search to be performed where child models can be selected as parents in the next generation based not only on accuracy or loss, but also the performance of each model.

In still further implementations, the hardware emulation is adapted to expose certain metrics for each individual inference operation of the model. Thus, for instance, two different convolution operations might have different latencies, different memory footprints, different power consumption, etc. By exposing per-operation metrics during generation and evaluation of the models, the model search can be guided to favor selection of not only accurate, but efficient operations. For instance, when generating child models, a weighting scheme can be employed that favors adding efficient operations to a parent model. The weighting can be proportional to the performance of a given inference operation with respect to a given metric. Individual inference operations can be randomly selected according to the weighting scheme so that relatively more efficient inference operations are more likely to be selected, but the model space can still be adequately explored.

In addition, note that a single seed model can be transformed into multiple final models to suit different objectives for different device contexts. For instance, as discussed more below, one final model could be generated using a search that considers both accuracy and power consumption metrics, and another final model could be generated using another search that considers accuracy and memory utilization metrics. The first final model could be selected and executed when the current device context indicates that available power is constrained (e.g., the device is not plugged in and/or battery level below a threshold) and the second final model could be executed when the current device context indicates that available memory is constrained (e.g., memory utilization above a specified threshold percentage).

In still further implementations, models can be generated for computing systems that have multiple processing units. For instance, consider a scenario where a single computing device has both a conventional CPU and an NPU. By considering the bandwidth between the CPU and the NPU, a model can be generated by considering not only which operations to employ but also whether those operations will be executed on the CPU or on the NPU. Thus, for instance, a final model might have a first path of operations that is designated to execute on the CPU and a second path of operations that is designated to execute on the NPU.

### Evaluating and Designating Child Models as Parents

As noted previously, certain child models are selected during evaluation 320 and added to the parent model store 304 for use as parent models in subsequent generations. One approach for deciding which child models to add to the parent model store involves using one or more metrics to predict which child models are likely to produce offspring that, in subsequent iterations, will exhibit improvements relative to previously-discovered models. Generally, the metrics can consider factors such as the loss or accuracy of a given child model, latency of a given child model, power consumption of a given child model, computing resource consumption (e.g., memory consumption) of a given child model, and so on. Child models that exhibit characteristics such as relatively low loss or high accuracy, low latency, low power consumption, and/or low computing resource consumption can be favored for selection as parent models in the next generation.

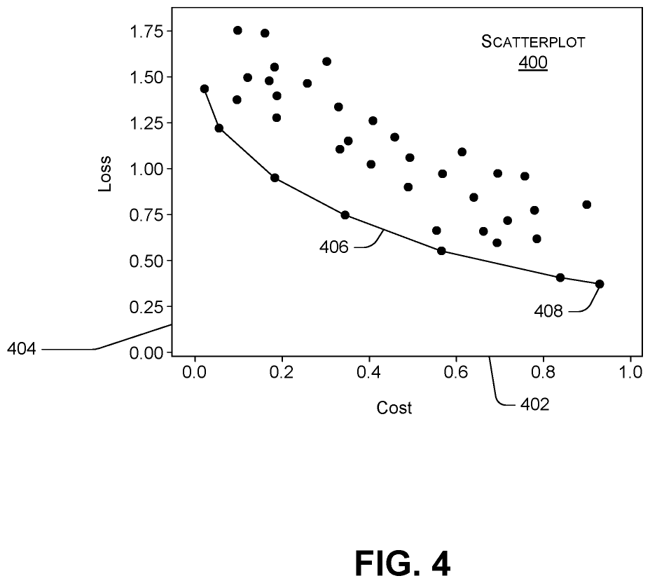

One specific approach to selecting child models for the parent pool is shown herein with respect to FIG. 4. This figure illustrates an example scatterplot 400 for various trained models. For each child model that completes training, the cost of that child model can be computed and plotted on x-axis 402, where the cost can be defined based on latency, power consumption, computing resource consumption, etc. In some cases, the cost can be normalized to a number between 0 and 1, as shown in FIG. 4. In addition, the loss of that child model can be computed and plotted on y-axis 404. Once all models for a given iteration have been plotted, a lower convex hull 406 can be computed from the plotted values.

The lower convex hull 406 can be used as a mechanism to decide whether a given child model is added to the parent model pool. For example, a child model on the lower convex hull can be added to the parent model pool with a probability defined using the following specific algorithm. If m₁ and m₂ are two adjacent models on the hull, with costs c₁ and c₂(c₁<c₂), then the probability weight of m₁ can be set proportionally to c₂−c₁. The most accurate model, which has no following model on the curve, can be selected for inclusion within the parent model pool with probability 0.5. In FIG. 4, the most accurate model is model 408, since this model has the lowest loss.

Generally, a lower convex hull is a subset of the Pareto frontier, and thus another approach is to select child models on the Pareto frontier for inclusion into the parent pool. Either approach can provide good performance for selecting child models to add to the parent model pool. One way to view the lower convex hull and/or the Pareto frontier is as follows. A given model on the lower convex hull or Pareto frontier cannot be improved with respect to one metric by moving to another model on the lower convex hull/Pareto frontier without degrading the other metric.

Note that the same models may have different validation errors due to randomness in forming stochastic gradients. As a consequence, the lower convex hull or Pareto frontier can be relaxed with a multiplicative bandwidth. Thus, a child model whose validation error is within (1+γ) times the lower convex hull validation error at the same computational cost can considered to be on the lower convex hull and can be chosen as a parent. Some implementations can be set to γ=0.025. This approach allows certain child models that are proximate to the lower convex hull, yet not strictly located thereon, to still be designated as parent models.

Other approaches may also be used to allow child models that have locations within a predetermined vicinity of the lower convex hull to be selected as parent models. For example, some implementations can define a threshold distance from the lower convex hull, and allow child models within the threshold distance of the lower convex hull to be selected as parent models. This is just one of various approaches that can be used to select a subset of one or more child models as a parent model, based on one or more metrics.

FIG. 4 shows models that have completed training as black dots. For purposes of explanation, assume that FIG. 4 represents the state of scatterplot 400 after iteration N. One or more of the child models on or near lower convex hull 406 can be selected as parent models for a subsequent iteration N+1, where additional operations be added from further child models, as discussed above.

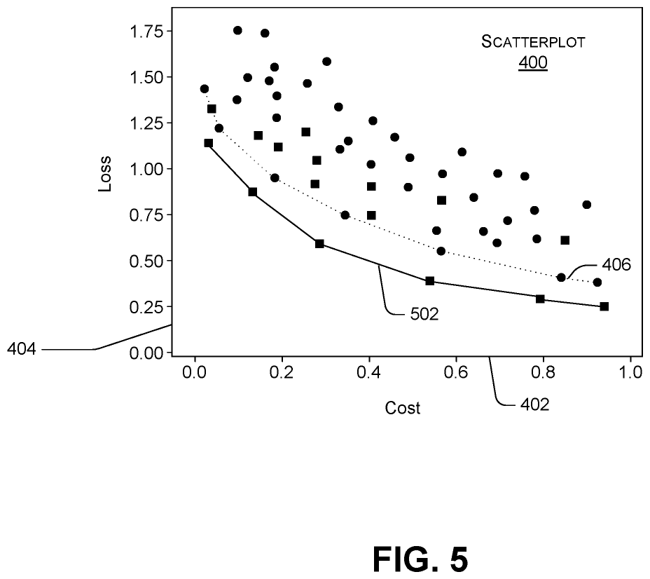

FIG. 5 shows scatterplot 400 in a subsequent state after iteration N+1. Child models trained during iteration N+1 are shown in FIG. 5 using squares. A new lower convex hull 502 can be computed. Previous lower convex hull 406 is shown as a dotted line to illustrate movement of the lower convex hull downward in iteration N+1.

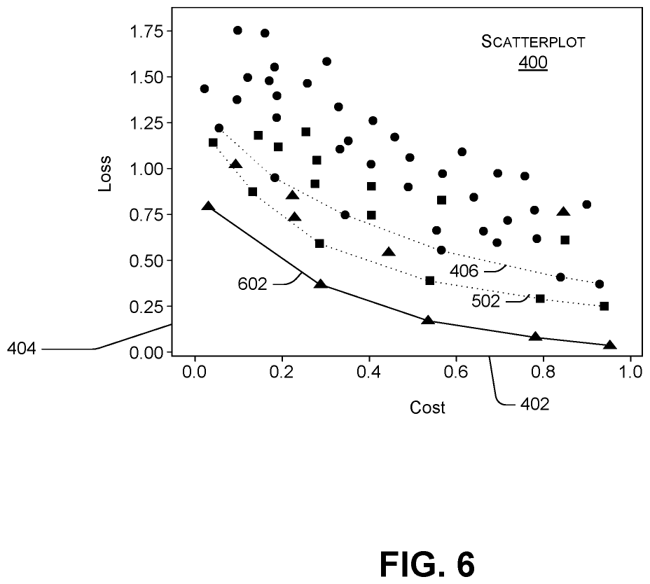

Again, one or more of the child models in or near lower convex hull 502 can be selected for a subsequent iteration N+2. Child models trained during iteration N+2 are shown in FIG. 6 as triangles. A new lower convex hull 602 can be computed, and previous lower convex hulls 406 and 502 are shown in dotted lines to illustrate their position relative to lower convex hull 602.

One way to view the approach shown in FIGS. 4-6 is a greedy approach to finding cost-efficient predictors. Note that this is a multi-objective approach, considering both loss/accuracy as well as model performance with respect to latency, power consumption, or resource utilization. Alternative implementations might use different and/or additional metrics, e.g., multi-dimensional plots of three or more metrics, an objective function defined over one or more metrics, etc.

The approach set forth above generally grows networks using a randomized approach. However, instead of a purely random approach which might be computationally infeasible, the approach is guided by favoring the selection of known good models as a basis for further modification. As noted previously, training a model from scratch can be very computationally intensive. For example, a training data set might include millions of training data items, and a given model might need to be trained over several training epochs before convergence. A training epoch can involve one forward propagation and one backpropagation operation through an entire model for each data item in the training data set.

The approach set forth above offers various benefits relative to conventional approaches for automated model generation. Note that not every child model is used as a parent model for subsequent iterations. Rather, by using a subset of child models that occur along the lower convex hull as new parent models, the disclosed implementations start each new iteration with child model structures that inherit the parent model structure of known good models. This allows subsequent iterations to proceed without training models that occupy a significant portion of the search space that is far away from the lower convex hull, and can save a tremendous amount of training time. In addition, by using not only accuracy but cost as a criterion for selecting which child models to use as new parent models, the disclosed implementations disfavor the generation of new models that tend to have high latency or consume significant power or computational resources.

Recall that previous techniques for automated generation of machine learning models tended to generate models that do not fully leverage modern inference hardware. In contrast, the techniques described herein not only consider the availability of specific inference operations when generating models, but also how those specific inference operations tend to influence characteristics of the resulting models, such as latency, power consumption, and resource utilization.

### Example System

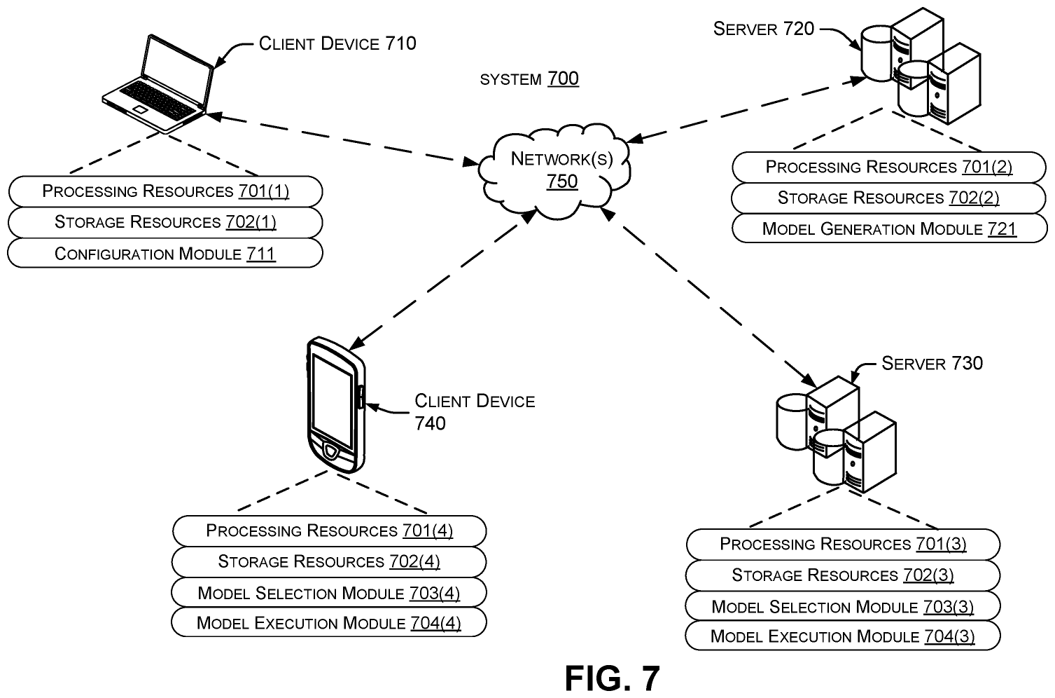

The present implementations can be performed in various scenarios on various devices. FIG. 7 shows an example system 700 in which the present implementations can be employed, as discussed more below.

As shown in FIG. 7, system 700 includes a client device 710, a server 720, a server 730, and a client device 740, connected by one or more network(s) 750. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 7, but particularly the servers, can be implemented in data centers, server farms, etc.

Certain components of the devices shown in FIG. 7 may be referred to herein by parenthetical reference numbers. For the purposes of the following description, the parenthetical (1) indicates an occurrence of a given component on client device 710, (2) indicates an occurrence of a given component on server 720, (3) indicates an occurrence on server 730, and (4) indicates an occurrence on client device 740. Unless identifying a specific instance of a given component, this document will refer generally to the components without the parenthetical.

Generally, the devices 710, 720, 730, and/or 740 may have respective processing resources 701 and storage resources 702, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client device 710 can include a configuration module 711 that can interact with a model generation module 721 on server 720. Generally speaking, the configuration module can provide certain configuration parameters to the model generation module. The model generation module uses these configuration parameters to perform model generation as discussed herein. In particular, the model generation module can perform model generation workflow 300 based on the configuration parameters.

The model generation module 721 can output a final model to server 730 and/or client device 740. Server 730 and client device 740 can have respective instances of a model selection module 703 and a model execution module 704. For instance, the model selection module can select from multiple models generated by server 720 according to context, such as resource constraints. The model execution module 704 can execute the selected model.

### Example Graphical Interface

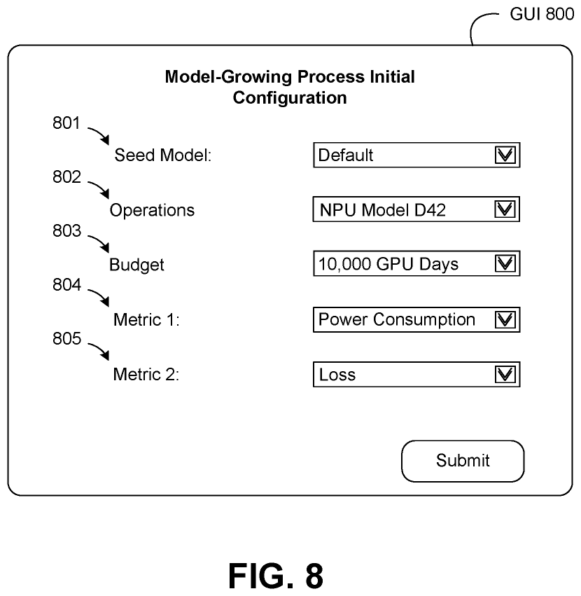

As noted above, the configuration module 711 on client device 710 can provide initial configuration parameters to the model generation module 721. The model generation module 721 can perform model generation workflow 300 according to the configuration parameters provided by the configuration module. FIG. 8 illustrates an example configuration graphical user interface (“GUI”) 800 that can be presented on client device 710 for a user to define these configuration parameters.

Seed model element 801 allows the user to specify what type of seed model or models should be used to start the search of the machine learning model space. In FIG. 8, the user is shown having selected a default parent model. For example, the model generation module 721 may provide a default neural network structure for use as a generic seed model. Other options can include a randomly-generated model, where the module generation module selects a random model structure for use as the seed model. Another option is for the user to navigate to an existing model that is known to provide relatively good performance for a specific task. In this case, the configuration module 711 can upload the designated model to the model generation module for use as the seed model.

Operations element 802 allows the user to specify what types of operations are considered by the model generation module 721. For example, the model generation module can provide various options for groups of operations supported by different inference hardware architecture. In FIG. 8, the user has selected NPU Model D42, which may have dedicated circuitry for performing specific operations of a specific inference hardware architecture. For instance, the NPU may have circuitry for performing convolution operations with specific tensor and kernel sizes in a single operation, circuitry for performing vector or matrix operations with specific input/output sizes in a single operation, circuitry for performing specific pooling or activation function operations, etc.

Budget input element 803 allows the user to specify a computational budget for model generation. For example, the user might specify a budget of 10,000 GPU-days, and the model generation module 721 can use this budget as a stopping condition. Alternative implementations might use other metrics, such as a number of processing operations, a number of virtual machines, an amount of time, etc., as computational budgets.

Metric 1 element 804 allows the user to specify a first metric for evaluating models, and metric 2 element 805 allows the user to specify a second metric. In FIG. 8, these metrics are shown as power consumption and loss, respectively. However, users may wish to specify other metrics, such as latency, power consumption, or resource utilization.

Note that the configuration parameters shown in FIG. 8 are merely exemplary, and various other implementations are contemplated. For example, in some cases, users can specify connectivity parameters. As an example, a user can specify that inserted operations can receive inputs from a specified number of previous layers, or a varying (e.g., random) number of previous layers. As another example, the user might specify whether skip connections are allowed, e.g., where one layer may not provide inputs to an immediately-subsequent layer but instead may skip the immediately-subsequent layer and connect to another subsequent layer. Users could also specify a densenet architecture where each layer is connected to all preceding layers in the model.

Also, note that some implementations may provide one or more GUIs to show progress of model search. For example, some implementations may generate GUIs showing scatterplot 400 changing across different iterations of model growth in a manner similar to that shown in FIGS. 4-6. Other implementations may show graphical representations of individual models as they are generated.

### Method for Hardware-Aware Generation of Machine Learning Models

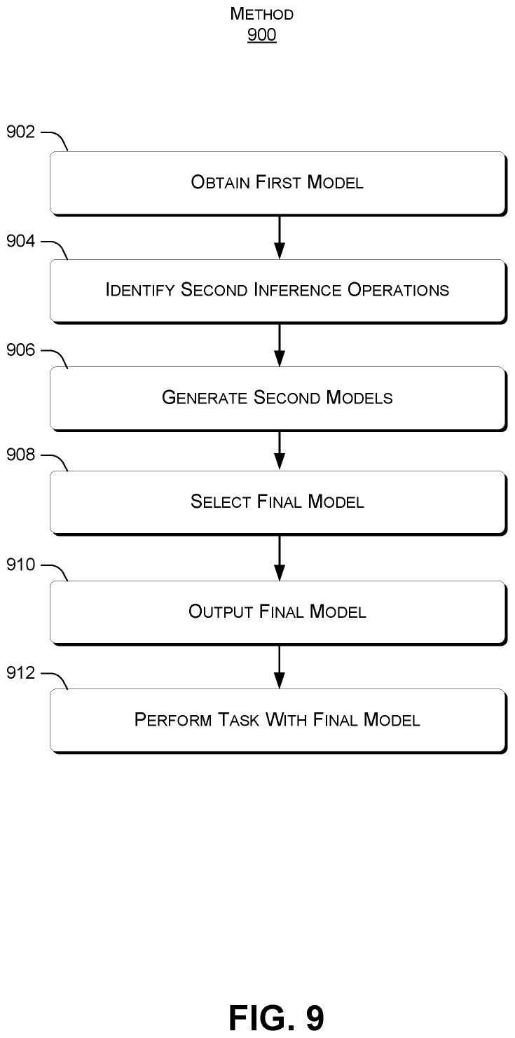

FIG. 9 illustrates an example method 900, consistent with some implementations of the present concepts. Method 900 can be implemented on many different types of devices, e.g., by one or more cloud servers, by a client device such as a laptop, tablet, or smartphone, or by combinations of one or more servers, client devices, etc.

Method 900 begins at block 902, where a first machine learning model is obtained. The first machine learning model can have one or more first inference operations.

Method 900 continues at block 904, where second inference operations are identified. The second inference operations can be supported by an inference hardware architecture. In some cases, the inference hardware architecture may not support some or all of the first inference operations of the first machine learning model obtained at block 902.

Method 900 continues at block 906, where second machine learning models are generated by modifying the first machine learning model to include individual second inference operations that are supported by the inference hardware architecture. Block 906 can also include training the second machine learning models, either from scratch or using transfer learning and/or warm start techniques.

Method 900 continues at block 908, where a final machine learning model is selected from the second machine learning models based on one or more metrics. For instance, the metrics can relate to losses or accuracy of the second machine learning models, latencies of the second machine learning models, power consumption by the second child machine learning models, or memory utilization by the second child machine learning models.

Method 900 continues at block 910, where the final model is output. For instance, block 910 can include sending the final model to a different device, registering the final model for use with a particular application, making the final model available via a web service, etc.

Method 900 continues at block 912, where a task is performed with the final model. For instance, block 912 can include providing input data to the final model, executing the final model on the input data to obtain one or more results, and outputting the results. The results can be output via an API to a particular application, can be output by being written to persistent storage, sent over a network to remote application, output via an I/O device such as a display or a speaker, etc.

### Method for Dynamic Runtime Selection of a Machine Learning Model

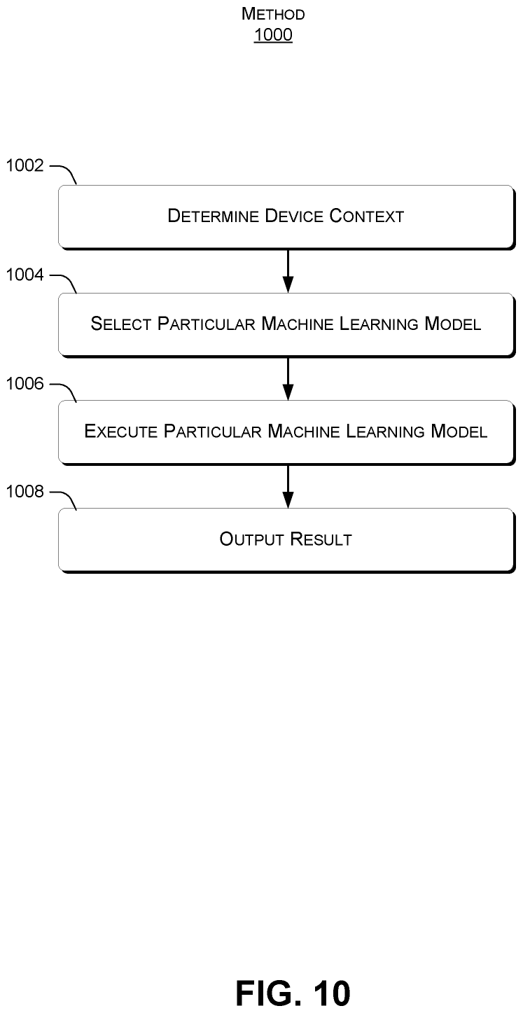

FIG. 10 illustrates an example method 1000, consistent with some implementations of the present concepts. Method 1000 can be implemented on many different types of devices, e.g., by one or more cloud servers, by a client device such as a laptop, tablet, or smartphone, or by combinations of one or more servers, client devices, etc.

Method 1000 begins at block 1002, where a device context is determined. For example, the device context can relate to resource availability for the device, such as memory, CPU, network, or storage utilization, whether the device is plugged in, etc.

Method 1000 continues at block 1004, where a particular machine learning model is selected from a plurality of machine learning models that are available to the computing device. For instance, some or all of the available machine learning models may be installed locally on the device, available for download by the device, etc. Individual models may be optimized or adapted for different device contexts, e.g., low power consumption, low memory utilization, low latency, low network or processor utilization, etc.

Method 1000 continues at block 1006, where the particular machine learning model is executed to perform a task. For instance, block 1006 can include providing input data to the particular model, executing the particular model on the input data to obtain one or more results.

Method 1000 continues at block 1008, where the results are output. The results can be output via an API to a particular application, can be output by being written to persistent storage, sent over a network to remote application, output via an I/O device such as a display or a speaker, etc.

### Alternative Implementations

The concepts described herein are conveyed above using an evolutionary search procedure to illustrate how a machine learning model space can be searched while considering the availability of hardware-supported inference operations. However, the specific techniques described above can be readily extended to various other approaches for automated generation of machine learning models.

For instance, consider approaches that employ reinforcement learning to find new model architectures. In some implementations, an exploration strategy can be provided that encourages searching of model architectures that have hardware-supported inference operations. Furthermore, a reward function can be defined that considers not only the overall model performance with respect to one or more metrics, but also per-operation metrics obtained via hardware emulation of these operations.

As another example, consider approaches that employ Bayesian optimization to explore new machine learning models. In some implementations, an acquisition function can be defined that considers the availability of and/or performance of hardware-supported inference operations in determining which models to explore. Similar approaches can be employed for one-shot model generation, e.g., by defining a supernetwork having candidate hardware-supported inference operations that are trained together and subsequently culled to select a particular path through the supernetwork as the final model.

### Technical Effect

As noted above, modern inference hardware architectures provide specific hardware instructions that implement operations that tend to be done in neural networks, such as convolution or matrix operations. For instance, inference hardware architectures can provide instructions that perform convolution operations with specific input/output tensor and/or kernel sizes, vector or matrix operations with specific input or output tensor sizes, pooling operations, activation functions, etc. When a machine learning model is developed with convolution or matrix operations that are supported by a given inference hardware architecture, the machine learning model can be run very efficiently on processing units that support that architecture.

However, as also noted above, conventional approaches for automated generation of machine learning models tend to be agnostic as to the availability of hardware-supported inference operations when developing new models. By searching for inference operations that are supported by an inference hardware architecture and modifying an existing model to include those supported inference operations, new models can be identified that exhibit comparable accuracy to the original model with significantly better performance. For instance, when executed on a processing unit that implements the inference hardware architecture, a new model might have lower latency, lower power consumption, lower memory utilization, etc.

Furthermore, the disclosed implementations allow for the generation of new machine learning models according to multiple metrics. Thus, multiple new models can be generated that are tailored to certain device contexts, such as availability of power or computing resources. As a consequence, the device can dynamically adjust which model is executed in different contexts.

Furthermore, the disclosed implementations allow for the generation of machine learning models in a manner that considers placement of individual inference operations on different processing units. In some cases, the search considers placement of certain inference operations on a processing unit that does not support the target inference hardware architecture, and another processing unit that does support the target inference hardware architecture. As a consequence, models can be generated that leverage the advantages of different types of processing units while considering the bandwidth between processing units for communicating of intermediate results during processing.

### Example Applications

The techniques discussed herein can be used for various applications, without limitation. Nevertheless, the following presents some specific examples for the sake of illustration.

As a first example, assume that an entity wishes to provide an application that performs background segmentation during video calls. This entity may have a preexisting model that they currently use for this purpose, and that model may execute on client device 740. However, assume that entity finds that the background segmentation model exhibits high power consumption and high latency, resulting in excessive battery consumption and occasional video jitter during video calls.

The entity can upload the preexisting model to model generation module 721 on server 720, and can configure various initial parameters as discussed above using configuration module 711. Next, the model generation module can modify the preexisting model by performing two different searches—one using a first set of metrics relating to accuracy/loss and power consumption, and another using a second set of metrics relating to accuracy/loss and latency. Thus, the model generation module may output two final models—a first final model optimized for low latency (potentially at the expense of higher power consumption), and a second final model optimized for low power consumption (potentially at the expense of some additional latency).

At runtime, the model selection module 703(4) on client device 740 can evaluate device context, such as whether the device is plugged in and/or the current battery level, to determine which model to use. If the device is plugged in and/or the current battery level is above a threshold (e.g., 80%), the first model can be selected and executed, thus providing a low-latency experience for the user with seamless background segmentation. If the device is not plugged in and/or the current battery level is below the threshold, the second model can be selected and executed, thus preserving battery power while potentially degrading the video experience somewhat relative to the first model.

Now consider a second example where an entity wishes to provide an object recognition service for user-uploaded images. The entity may have a preexisting model on server 730 that performs well at recognizing objects. However, that entity may find that at certain busy times the server 730 starts to run out of memory, and at other times electricity rates are very high and it is expensive to run the object recognition service.

As before, the entity can upload the model to model generation model 721 on server 720, configure the search, and obtain two new final models—a first model with relatively low memory utilization and a second model with relatively low power consumption. When memory is constrained on 730, the server can use the first model, and when electricity rates are high, the server can use the second model.

### Definitions

For the purposes of this document, the term “inference hardware architecture” refers to a set of operations provided by one or more processing units adapted for machine learning inference processing. For instance, the inference operations can be implemented in dedicated circuitry on the processing units that are configured to use specific data sizes (e.g., input sizes, output sizes, kernel sizes, etc.). The term “inference operation” refers to an operation performed by a machine learning model to perform a task. For instance, an inference operation can be performed by applying learned parameters obtained by training the machine learning model.

The term “learned parameters” refers to parameters such as edge weights and bias values that are learned by training a machine learning model, such as a neural network. The term “operation” refers to a function that can be performed by one or more nodes. The term “model structure” refers to an overall architecture of a model, including the number of layers or nodes, the connectivity of the layers, and/or the type of operations performed by individual layers. The term “neural network structure” refers to the model structure of a neural network. The term “trained model” refers to a model structure together with learned parameters for the model structure. Note that two trained models can share the same model structure and yet have different learned parameters, e.g., if the two models trained on different training data or if there are underlying stochastic processes in the training process.

The term “parent model” refers to a model that is subsequently modified to obtain a “child model.” A “seed model” is one type of parent model, e.g., a preexisting model that is selected as a starting point for a search of a machine learning model search space. The term “final model” is only used herein to imply that a given model is designated for practical use in an application. In some cases, a final model output by a first search of a machine learning model search space can be subsequently employed as a seed model to initiate a second search, resulting in a second final model.

### Device Implementations

As noted above with respect to FIG. 7, system 700 includes several devices, including a client device 710, a server 720, a server 730, and a client device 740. As also noted, not all device implementations can be illustrated and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 750. Without limitation, network(s) 750 can include one or more local area networks (LANs), wide area networks (WANs), the Internet, and the like.

Various examples are described above. Additional examples are described below. One example includes a method performed on a computing device, the method comprising obtaining a first machine learning model having one or more first inference operations, identifying a plurality of second inference operations that are supported by an inference hardware architecture, generating second machine learning models by modifying the first machine learning model to include individual second inference operations that are supported by the inference hardware architecture, and selecting a final machine learning model from the second machine learning models based on one or more metrics.

Another example can include any of the above and/or below examples where the one or more metrics relate to losses or accuracy of the second machine learning models.

Another example can include any of the above and/or below examples where the one or more metrics relate to latencies, power consumption, or memory utilization of the second machine learning models.

Another example can include any of the above and/or below examples where the method further comprises simulating execution of the second machine learning models on a central processing unit to determine the one or more metrics.

Another example can include any of the above and/or below examples where the method further comprises determining a frontier of the second machine learning models with respect to multiple metrics and electing the final machine learning model from the frontier.

Another example can include any of the above and/or below examples where the method further comprises performing two or more iterations of selecting a subset of the second machine learning models for further modification and generating further second machine learning models from the selected subset.

Another example can include any of the above and/or below examples where generating an individual second machine learning model comprises removing, from the first machine learning model, an individual first inference operation that is not supported by the inference hardware architecture.

Another example can include any of the above and/or below examples where the method further comprises executing the second machine learning models using hardware emulation of the individual second inference operations.

Another example can include any of the above and/or below examples where the method further comprises obtaining respective per-operation metrics via the hardware emulation and using the respective per-operation metrics to select individual second machine learning models as parent models for further modification or to select the final machine learning model.

Another example includes a hardware processing unit and a storage resource storing computer-readable instructions which, when executed by the hardware processing unit, cause the hardware processing unit to: perform a search of a machine learning model search space having a plurality of inference operations that are supported by an inference hardware architecture, the search involving emulation of the inference architecture hardware and output a final machine learning model selected from the machine learning model search space.

Another example can include any of the above and/or below examples where the inference operations include convolution operations, vector operations, or matrix operations having specified input and output data sizes.

Another example can include any of the above and/or below examples where the search is performed starting from a seed model that has been selected based on performance with respect to a particular task.

Another example can include any of the above and/or below examples where the seed model includes a particular inference operation that is not supported by the inference hardware architecture.

Another example can include any of the above and/or below examples where the final machine learning model does not include the particular inference operation.

Another example can include any of the above and/or below examples where the search involves training multiple machine learning models having different inference operations supported by the inference hardware architecture.

Another example can include any of the above and/or below examples where the search considers placement of individual inference operations on a first processing unit that does not support the inference hardware architecture and a second processing unit that does support the inference hardware architecture, and the final machine learning model indicates that certain inference operations are performed on the first processing unit and other inference operations are performed on the second processing unit.

Another example includes a computing device comprising: a hardware processing unit configured to execute a plurality of supported inference operations and a storage resource storing computer-readable instructions which, when executed by the hardware processing unit, cause the hardware processing unit to: determine a device context for the computing device, based at least on the device context, select a particular machine learning model from a plurality of machine learning models available to the computing device, the plurality of machine learning models having different supported inference operations, and execute the particular machine learning model to perform a particular task.

Another example can include any of the above and/or below examples where the device context relates to availability of power or memory on the computing device.

Another example can include any of the above and/or below examples where the computer-readable instructions, when executed by the hardware processing unit, cause the hardware processing unit to: in a first instance when availability of memory for the computing device is constrained, select a first machine learning model as the particular machine learning model to execute to perform the particular task, the first machine learning model having been generated based at least on a first metric relating to memory utilization and in a second instance when availability of power to the computing device is constrained, select a second machine learning model as the particular machine learning model to execute to perform the particular task, the second machine learning model having been generated based at least on a second metric relating to power consumption.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method performed on a computing device, the method comprising:
obtaining a first machine learning model having one or more first inference operations;
identifying a plurality of second inference operations that are supported by an inference hardware architecture;
generating second machine learning models by modifying the first machine learning model to include individual second inference operations that are supported by the inference hardware architecture; and
selecting a final machine learning model from the second machine learning models based on one or more metrics.

2. The method of claim 1, wherein the one or more metrics relate to losses or accuracy of the second machine learning models.

3. The method of claim 1, wherein the one or more metrics relate to latencies, power consumption, or memory utilization of the second machine learning models.

4. The method of claim 1, further comprising:
simulating execution of the second machine learning models on a central processing unit to determine the one or more metrics.

5. The method of claim 1, further comprising:
determining a frontier of the second machine learning models with respect to multiple metrics; and
selecting the final machine learning model from the frontier.

6. The method of claim 1, further comprising:
performing two or more iterations of selecting a subset of the second machine learning models for further modification and generating further second machine learning models from the selected subset.

7. The method of claim 1, wherein generating an individual second machine learning model comprises removing, from the first machine learning model, an individual first inference operation that is not supported by the inference hardware architecture.

8. The method of claim 1, further comprising:
executing the second machine learning models using hardware emulation of the individual second inference operations.

9. The method of claim 8, further comprising:
obtaining respective per-operation metrics via the hardware emulation; and
using the respective per-operation metrics to select individual second machine learning models as parent models for further modification or to select the final machine learning model.

10. The method of claim 1, further comprising:
outputting multiple final machine learning models selected according to different metrics.

11. A system comprising:
a hardware processing unit; and
a storage resource storing computer-readable instructions which, when executed by the hardware processing unit, cause the hardware processing unit to:
perform a search of a machine learning model search space having a plurality of inference operations that are supported by an inference hardware architecture, the search involving emulation of the inference architecture hardware; and
output a final machine learning model selected from the machine learning model search space.

12. The system of claim 11, wherein the inference operations include convolution operations, vector operations, or matrix operations having specified input and output data sizes.

13. The system of claim 11, wherein the search is performed starting from a seed model that has been selected based on performance with respect to a particular task.

14. The system of claim 13, wherein the seed model includes a particular inference operation that is not supported by the inference hardware architecture.

15. The system of claim 14, wherein the final machine learning model does not include the particular inference operation.

16. The system of claim 11, wherein the search involves training multiple machine learning models having different inference operations supported by the inference hardware architecture.

17. The system of claim 11, wherein the search considers placement of individual inference operations on a first processing unit that does not support the inference hardware architecture and a second processing unit that does support the inference hardware architecture, and the final machine learning model indicates that certain inference operations are performed on the first processing unit and other inference operations are performed on the second processing unit.

18. A computing device comprising:
a hardware processing unit configured to execute a plurality of supported inference operations; and
a storage resource storing computer-readable instructions which, when executed by the hardware processing unit, cause the hardware processing unit to:
determine a device context for the computing device;
based at least on the device context, select a particular machine learning model from a plurality of machine learning models available to the computing device, the plurality of machine learning models having different supported inference operations; and
execute the particular machine learning model to perform a particular task.

19. The computing device of claim 18, the device context relating to availability of power or memory on the computing device.

20. The computing device of claim 19, wherein the computer-readable instructions, when executed by the hardware processing unit, cause the hardware processing unit to:
in a first instance when availability of memory for the computing device is constrained, select a first machine learning model as the particular machine learning model to execute to perform the particular task, the first machine learning model having been generated based at least on a first metric relating to memory utilization; and
in a second instance when availability of power to the computing device is constrained, select a second machine learning model as the particular machine learning model to execute to perform the particular task, the second machine learning model having been generated based at least on a second metric relating to power consumption.
